(19) United States
(12) Patent Application Publication
(10) Pub. No.: US 2015/0272179 A1
(43) Pub. Date: Oct. 1, 2015

(54) PROCESS FOR PREPARING A COMPRESSED POPCORN FOOD PRODUCT AND FOOD PRODUCT OBTAINED BY SUCH PROCESS

(71) Applicants: Carlos ARCUSIN, (US); Gustavo Alfredo GARCIA, (US); Claudio SCHENA, (US)

(72) Inventor: Carlos Arcusin, Buenos Aires (AR)

(21) Appl. No.: 14/433,791

(22) PCT Filed: Oct. 2, 2013
(86) PCT No.: PCT/EP2013/070571

§ 371 Date: Apr. 6, 2015

(30) Foreign Application Priority Data
Oct. 5, 2012 (AR) P12 01 03740

(51) Int. Cl. A23L 1/18; A23L 1/00

(52) U.S. Cl. CPC A23L 1/1817; A23L 1/1812; A23L 1/0017; A23V 2002/00

(57) ABSTRACT

A process for preparing a compressed popcorn (15) food product is provided. Process steps include: cooking (1), cooling (2), fractioning (3), heating (4), compressing (5) and ejection and packing (6). Popcorn (15) is made from maize grains (13) which are then compressed (5) to obtain compressed food product portions. The invention also relates to a manufactured food product (53) comprising compressed popcorn (15) resulting from the maize grains (13) and a sweetener (14) cooked without the addition of fat substances. The resulting food product (53) may also include additional food ingredients. The different shapes of the compression containers (50) make it possible to obtain different types of candies, food bars or blocks, etc.

### FIELD OF THE INVENTION

This invention relates to the field of everyday-life needs and particularly to the field of food processing methods.

More particularly, it consists of a process for preparing a compressed popcorn food product, comprising a series of steps through which the popcorn is cooked together with sweeteners, fractioned and compressed without added fats and oils. This invention also refers to the food product obtained using said process, the sweet flavor of which preserves that of popcorn, but has a more compact consistency, similar to that of nougat, but lighter and free from added fats and oils.

### BACKGROUND OF THE INVENTION

As is well known, popcorn is obtained by heating maize grains, also known as popping corn, of the variety everta, until they burst or pop.

The ability of popping corn (maize, Zea mays var. everta) to pop, is due to the fact that its kernel contains a small amount of water or moisture, surrounded by a starchy hull. All this is inside of the outer hull of the grain.

When heated, the water inside the kernel expands and builds up pressure which increases until the hull ruptures and the kernel pops.

Popcorn or popping corn is made from a special corn, maize, Zea mays var. everta.

Although the corncob is similar to that of other corn types, only the everta strain has the ability to pop.

Although this corn has excellent nutritional values, the use of fat substances in its cooking process to make it pop, results in a nutritional disadvantage.

One first step was given by the same inventor of this invention, who disclosed a corn grain prepared for cooking without adding any fat substances and a process for obtaining such maize grain, as disclosed in patent ARR050105219.

Up to the present no industrial process has been disclosed making it possible to obtain a food product based on popcorn with a sweetener added and then compressing it without using any fat substances.

### Advantages and Aim of the Invention

One first object is to provide a process for obtaining a compressed, crunchy food, in some way similar to traditional nougat, but with a popcorn flavor.

Another object is to obtain such compact food without using any fat substances.

An advantage of this process is that a unique product is obtained, since it is more consistent than conventional popcorn, has the sweet-flavoring contribution of the sweetener, and the final product is lighter and more easily digested than conventional nougat.

Another related advantage is that honey may be used as a sweetener, which is a healthy and natural energetic contribution to the food product obtained.

Another advantage is that, since the process of the invention can be applied without adding any fats, the food product so produced and properly packed may keep its organoleptic characteristics for a long time without alterations. This makes a great difference from traditional processes where fat substances and oils are used, which eventually alter quality of food products.

Another advantage for the consumer public is that popcorn is provided in a manner other than the traditional way, i.e. in small compressed portions that may be in the form of bars, tablets, etc.

Yet another advantage is that, since the cooking process can be carried out without the addition of fat substances, the popcorn obtained may be eaten without causing health problems such as weight gain, cholesterol increase, obesity, etc.

Another advantage as compared with other compact food products such as nougat, is that this product has a much lower weight, and is therefore more easily handled, transported and stored as well as carried by the consumer.

Another advantage is that the processed maize grain has more shelf stability since it includes all the advantages of dry products. A further advantage originated in shelf stability, is a substantial cost reduction resulting from less demanding packaging requirements.

Yet another advantage is that this process makes it possible to use additional food ingredients such as: nuts (chestnuts, almonds, hazelnuts, etc.); dehydrated fruit of different types (raisins, apples, pears, peaches, etc.); powdered ingredients such as cocoa powder, coconut powder, etc.; other cereals, such as inflated cereals, etc.

### BRIEF DESCRIPTION OF THE FIGURES

For the sake of clarity and better understanding of the subject matter of the invention several figures have been included representing one of its preferred embodiments, for illustrative, not limitative purposes:

FIG. 1 is a schematic representation of the process of the invention for producing a compressed popcorn food product, illustrating the main steps and means involved.

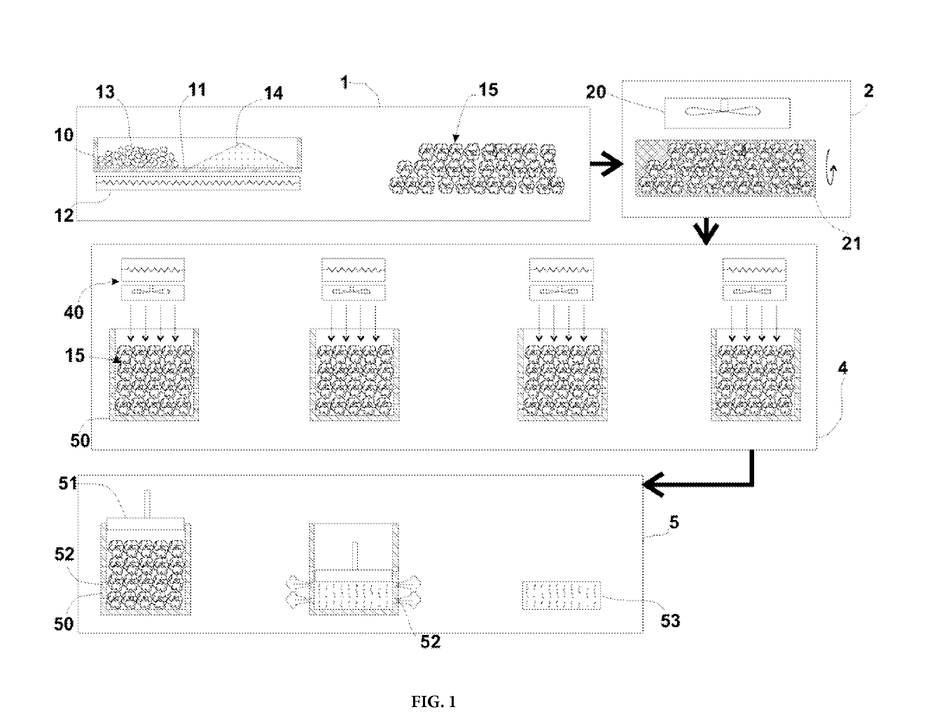

FIG. 2 is a schematic diagram representing the steps and sequence of the process of the invention.

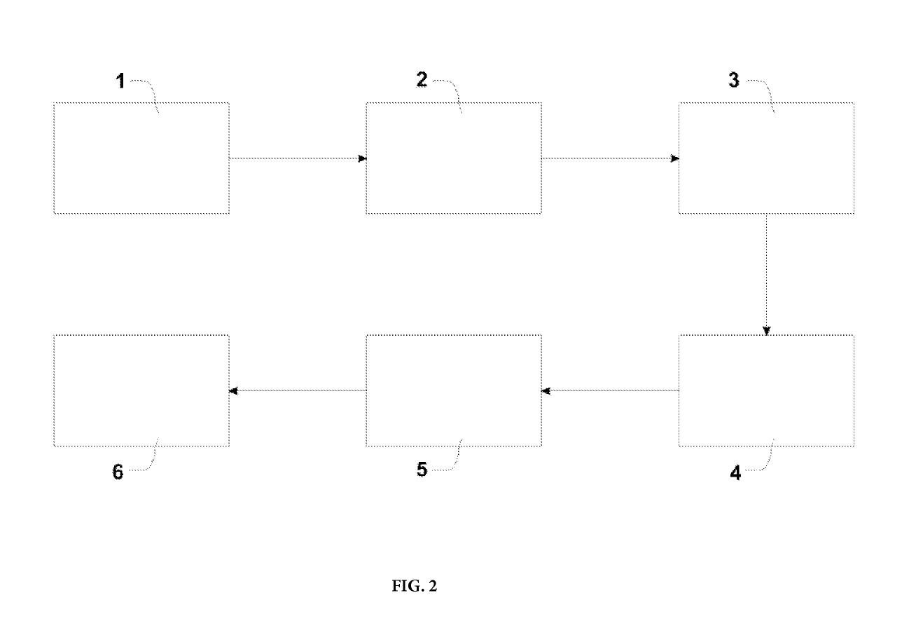

FIG. 3 is a schematic diagram representing the steps and sequence of the process of the invention, in an embodiment including an intermediate storage and/or transportation step.

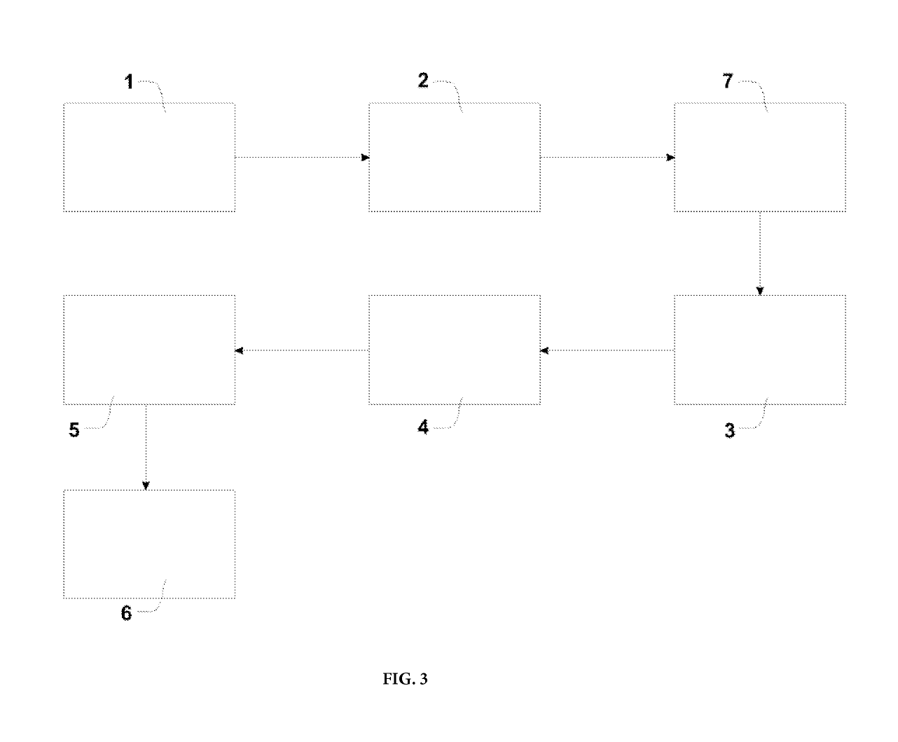

In the different figures, same numerals and/or letters indicate similar or matching parts.

### LIST OF REFERENCES IN THE FIGURES

(1) Popcorn production step [cooking of corn (13) and sweetener (14)]
(2) Cooling of popcorn step.
(3) Fractioning step.
(4) Successive micro heating periods steps
(5) Compression step.
(6) Ejection and packing step.
(7) Intermediate storage and/or transportation step
(10) Cooking device.
(11) Cooking surface
(12) Heating means.
(13) Corn
(14) Sweetener
(15) Popcorn.
(20) Cooling means.
(21) Open cooling container.
(40) Micro-heating device.
(50) Container and compression mold
(51) Compression means.
(52) Compressor openings
(53) Compressed food product

### SUMMARY OF THE INVENTION

In broad terms, this invention relates to a process for producing a compressed popcorn food product, comprising steps (1), (2), (3), (4), (5), and (6) to obtain popcorn (15), said popcorn being compressed until compressed food portions are produced (53). The invention also relates to a manufactured food product (53) comprising compressed popcorn (15) made from the maize grains (13) and sweetener (14) cooked without the addition of fat substances.

### DETAILED DESCRIPTION OF THE INVENTION

More particularly, the process of the invention for producing compressed popcorn (15) comprises cooking maize grains (13) without using fat substances, being the kernel of said grains capable of bursting, upon cooking, and becoming popcorn (15).

In a first step (1) maize grains (13), for example of the variety everta, and a sweetener (14) are placed on the surface of a cooking device (10) capable of cooking under constant stirring. Maize grains (13) will be preferably Zea mays var. everta grains, while the sweetener (14) can be of any type fit for melting over or covering the popcorn with caramel to enhance its flavor. Therefore, when a sweetener is mentioned it may be understood as any substance, either natural or artificial to sweeten the maize grains (13) such as, for example, honey, sucrose, dextrose, fructose, glucose, sugar of different types, musts, different types of syrup, grape syrup, etc.

The cooking device (10) provides a thermal conductive cooking surface (11) and is under the influence of a heating device (12) and of moving or stirring means. Said surface (11) will be preferably be made of a good thermal conductive metal such as for example, aluminum, stainless steel, etc.

Without the addition of any fat substances, the cooking device is switched on (10), and the corn (13) and the sweetener (14), are cooked together until said sweetener (14) melts and fully or partially covers or impregnates the maize grains (13). The cooking process continues until the maize corns pop (13) and popcorn (15) is obtained. Cooking temperature shall be kept within a range from at least 150° C. to a maximum of 220° C. with a tolerance of ±10%.

The popcorn (15) so obtained passes to step (2) where it is cooled while stirring. This is implemented by placing the popcorn (15) in an open container (21) and stirring under the effects of cooling means (20). In this way, the maize grains now converted into popcorn (15) are cooled and remain substantially separated from each other.

An optional intermediate step (7) in which popcorn (15) is temporarily stored and/or transported to continue with the process at some other time or place has also been foreseen. To this end, popcorn (15) must be prepared and kept in a place where it is preserved from factors such as moisture, so as to be preserved in optimal condition for the subsequent steps.

Then, by means of any device fit for such purpose, popcorn (15) is fractioned (3) by separating it into portions that are placed into compression containers (50).

A further possibility has been considered comprising the addition of one or more additional food ingredients at the step of fractioning (3) popcorn (15). These additional food ingredients may be selected from a group comprising: Nuts (such as chestnuts, almonds, hazelnuts, etc.); dehydrated fruit of different types (such as raisins, apples, pears, peaches, etc.); powdered ingredients such as cocoa powder, coconut powder, etc.; other cereals, such as inflated cereals, etc.

Preferably, those food ingredients will be added in a proportion such that popcorn (15) makes up at least 50% of the total volume.

After fractioning (3), the popcorn portions (15) will be heated but without reaching toasting level. In a preferred embodiment, successive intense but short heating or micro-heating periods are applied. To do so, a micro-heating device (40) is provided, which is capable of producing the above mentioned intense and short heating periods. Such heating periods must be applied at temperatures of up to 150° C. and for periods of less than 10 seconds.

For example, 2 to 6 heating periods of 1 second each. In this way popcorn (15) is heated to a convenient point, i.e. below the toast level, to avoid affecting quality and taste.

Once the popcorn (15) is hot, it is compressed (5) until its volume is substantially reduced to obtain the compressed food products (53). The compression container (50) is prepared for this operation, since it contains a compression means (51) and openings (52) releasing air during the compression process. In addition, before the compression step (5), it is possible to apply one or more non-stick substances on the walls of the containers used for compression (50).

In this step (5) it is possible to reach a suitable compressed product (53), with a high compression level in which the volume of popcorn portions (15) is reduced to less than 50% of their initial volume.

In these conditions, the compression container (50) becomes the molding means, since its shape and size will determine the form and size of the portions obtained.

Finally, the compressed food portions (53) are ejected from the compression containers (50) and packed for shipment.

Food Product:

The compressed food product comprises substantially compressed popcorn (15) portions. This popcorn (15) is compressed and comprises maize grains (13) with a sweetener (14). The maize grains (13) and the sweetener (14) are free of added fat, since no fat/oil substances are used in the cooking process. Therefore, these maize grains (13) are popped and they are fully or partially covered or impregnated with sweetener (14) that melts during the cooking process.

The sweetener (14) may be any type of sweetener fit to provide flavor, melt or caramelize, such as for example: honey, sacarose, dextrose, fructose, glucose, different types of sugar, must, different types of syrup, grape syrup, etc.

In other embodiments, this food product can include one or more food components which, as a whole, do not exceed 50% of the total volume since the popcorn part (15) will amount to 50% or a higher proportion of the total volume.

These food ingredients may be: nuts (such as chestnuts, almond, hazelnuts, etc.); dehydrated fruit of different types (such as raisins, apples, pears, peaches, etc.); powdered ingredients such as cocoa powder, coconut powder, etc.; other cereals, such as inflated cereals, etc.

As regards shape, as it depends on the shape and dimensions of the compression container (50), different shapes have been foreseen. In this way, the compressed food product can be presented in the form of candies, bars, blocks, etc.

### Example 1

For example, the compressed food product (53) can be produced in a way such that the following values may be measured at the compression step (5):

TABLE 1

| Variable | Value |
|---|---|
| Length | 150 mm |
| Width | 50 mm |
| Thickness before the | 70 mm |
| compression step | |
| Thickness after the | 25 mm |
| compression step | |
| Pressure applied | 150 kg to 8 bar |

### Example 2

For example, the compressed food product (53) can be produced in a way such that the following values are found at the fractioning step (3):

TABLE 2

| | | Additional food | |
|---|---|---|---|
| | Popcorn | ingredients | Total volume |
| Type | [volume %] | [volume %] | [%] |
| I. | 100 | 0 | 100 |
| II. | 90 | 10 | 100 |
| III. | 80 | 20 | 100 |
| IV. | 70 | 30 | 100 |
| V. | 60 | 40 | 100 |
| VI. | 50 | 50 | 100 |

Table No. 2 shows six exemplary cases showing that, by maintaining the preferential proportion in which popcorn (15) is at least, 50% of the volume (type VI) all other variants with a higher percentage of popcorn (15) are suitable.

Anyone with an average skill in the art will recognize that, when this invention is put into practice, many changes may be introduced as regards structure and shape, without departing from the essential principles clearly stated in the following claims.

Having thus particularly described and determined the nature of this invention, and the way in which it may be put into practice, we hereby claim exclusive right and property on:

1. A process for producing a compressed popcorn food product made of maize grains cooked without using fat substances, the kernel of said grain being capable of bursting upon cooking to form popcorn (15).
wherein said process comprises the steps of:
cooking by contact-heating and mixing with constant stirring maize grains with a sweetener, until they are cooked and become popcorn, where the sweetener, melted as a result of heating, covers at least partially the popcorn.
immediately cooling the resulting popcorn by simultaneous cooling and stirring it in such a way that maize grains now converted into popcorn remain substantially separated from each other.
fractioning portions of said popcorn and placing them in compression containers.
applying heat to such popcorn portions such that they are not heated to toast level.
compressing the heated popcorn portions until their volume is substantially reduced and thus obtaining compressed portions, and
ejecting such compact portions from said compression containers and packing them.

2. A process for making a compressed popcorn food product according to claim 1, wherein the step of applying heat to the popcorn portions comprises a series of intense and short heating periods so as to heat the popcorn below the toast level.

3. A process for making a compressed popcorn food product according to claim 1, wherein the maize grains and the sweetener are heated, stirred and mixed in contact with a thermal conductive surface, which under the influence of a heating means, cooks such food product, said surface comprising a metallic element that is a good thermal conductor.

4. A process for making a compressed popcorn food product according to claim 1, wherein the step of applying heat to cook and mix with constant stirring includes controlling the temperature so as to keep it within a range from 150° C. to 220° C. with a tolerance of ±10%.

5. A process for making a compressed popcorn food product according to claim 1, wherein the step of cooling and simultaneously stirring the popcorn comprises cooling performed in an open container through which cooling air circulates.

6. A process for making a compressed popcorn food product according to claim 1, wherein
in the cooking step, the sweetener is selected from a group comprising honey, sucrose, dextrose, fructose and glucose.

7. A process for making a compressed popcorn food product according to claim 1, wherein in the cooking step, the sweetener is selected from a group comprising honey, different sugar types, musts, different types of sugar and grape syrup.

8. A process for making a compressed popcorn food product according to claim 1, wherein after the step of simultaneously cooling and stirring the popcorn until the grains are separated from each other, an optional step is provided comprising temporarily storing this food product so as to preserve it from moisture, before proceeding to the step of fractioning portions of popcorn and introducing them into compression containers.

9. A process for making a compressed popcorn food product according to claim 1, wherein before the compression step, a fractioning step is provided to supply the popcorn into a compression container.

10. A process for making a compressed popcorn food product according to claim 2, wherein the step of applying successive intense and short heating periods, comprises applying heat by means of a stream of hot air.

11. A process for making a compressed popcorn food product according to claim 2, wherein the step of applying successive intense and short heating periods, comprises applying heat at temperatures below 150° C., for periods shorter than 10 seconds.

12. A process for making a compressed popcorn food product according to claim 1, wherein the step of compression of the heated popcorn portions, comprises compressing until the volume of such portions is reduced to 50% of their initial volume.

13. A process for making a compressed popcorn food product according to claim 1, wherein the compression container is the molding means of each portion.

14. A process for making a compressed popcorn food product according to claim 1, wherein the compression container has openings for releasing air during the compression operation.

15. A process for making a compressed popcorn food product according to claim 1, wherein before compressing popcorn, a non-stick substance is applied on the walls of the containers used for compressing said product.

16. A process for making a compressed popcorn food product, according to claim 1, wherein in the step of fractioning the popcorn, adding at least one more food ingredient, comprises adding said food ingredient/s up to a limit where popcorn amounts to at least 50% of the total volume.

17. A food product manufactured by using the process of the preceding claims wherein said food product comprises at least:
a substantially compact portion of compressed popcorn, such popcorn comprising maize grains cooked using a cooking process free from any fat substances and,
said maize grains containing, at least partially, a sweetener which has been added during the cooking process.

18. A food product according to claim 17, wherein said food product comprises at least one additional food ingredient.

19. A food product according to claim 17, wherein said food product comprises a substantially compact portion of compressed popcorn and, at least one additional food ingredient, such portion of popcorn amounting to at least 50% of the total volume.

20. A food product according to claim 17, wherein the portion is presented as a candy.

21. A food product according to claim 17, wherein the portion is presented as a food bar.

22. A food product according to claim 17, wherein the portion is presented as a food block.
